(19) United States
(12) Patent Application Publication
(10) Pub. No.: US 2004/0117364 A1
(43) Pub. Date: Jun. 17, 2004

(54) Information processing device, relay device, server, communication method and program

(75) Inventors: Makiko Kobayashi, Inagi (JP); Tsutomu Yamada, Inagi (JP); Mitsuyoshi Yamagishi, Kawasaki (JP); Etsuko Sasaki, Yokohama (JP); Junichi Mashiko, Kawasaki (JP); Makiko Nakao, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/713,155

(22) Filed: Nov. 17, 2003

(30) Foreign Application Priority Data
Nov. 19, 2002 (JP) 2002-335586

(51) Int. Cl. G06F 7/00

(52) U.S. Cl. 707/3

(57) ABSTRACT

An information processing device comprises a display control unit for making a display device display a screen containing a data input box for data specified by data identifying information in accordance with definition information on the screen, a storage unit for storing the data inputted to the data input box together with the data identifying information, and a control unit for searching for the data corresponding to the data identifying information from the storage unit when having the screen displayed, and setting the searched data into the data input box specified by the data identifying information.

### BACKGROUND OF THE INVENTION

The present invention relates to a user interface.

When a user accesses a Web site on the Internet by use of Browser, there is a Web site for requesting the user to input data. For example, there is the Web site for making a request for inputting an ID or a password for identifying the user. Further, on a Web site where the user can purchase a commercial article, etc., a name, an address, a telephone number, etc. of the user might be requested to be inputted.

On such a Web site, if the ID, the name, the address, the telephone number, etc. of the user, which have ever been inputted in the past, are again requested to be inputted, the user feels this very troublesome. Further, for instance, in the case of purchasing the commercial article by utilizing, for instance, a plurality of commercial article sales sites, information such as the address, etc. is repeatedly requested from the respective Web sites.

In such a case, as a technology for avoiding the input of the same data, the following public-known documents (patent documents 1-3) are known.

The patent document 1 discloses a technology for saving such a labor that the user inputs the information such as the name, the telephone, the address, etc. each time. In this document, however, on a limited Web site for providing a catalogue shopping service, limited data, for example, the name, the address, etc. are recorded for every user, and the labor of inputting the data once again is saved. Accordingly, the labor of inputting the data can not be saved in a general-purpose manner for the whole of the Web site.

The patent document 2 discloses a technology of restraining a data input operation of a terminal user down to a minimum by having a screen displayed simply by having a function key pressed, which screen is accompanied by input screen data prepared beforehand. This technology is also limited in its application range to the screen within a predetermined user program, and is not what can be applied to the whole of the user program.

The patent document 3 discloses a technology of storing, on the occasion of executing interactive program, data and commands outputted to a display device and data and commands inputted by an operator, and avoiding, on the occasion of re-executing this interactive program, the inputting each time the execution is done by supplying the stored data and commands. This technology is also limited in its application range to the data input when executing the predetermined program, and is not what can be applied to the whole of the program.

Moreover, in a Web site browsing program provided by Microsoft Corp., U.S.A., a function called AutoComplete (which will hereinafter be simply called an AutoComplete function) is provided. This AutoComplete function, however, stores data inputted from a user on every Web site in the process of being browsed. Therefore, even in the case of inputting the data on one Web site, the re-inputting is needed in the case of doing the same inputting on other Web sites.

Further, just as the user utilizes the AutoComplete function, for instance, it follows that a password to a user's ID is to be stored. Hence, in an environment where a plurality of persons share a personal computer, a protection of privacy is not sufficient.

Furthermore, in the AutoComplete function, in case the user employs a plurality of personal computers, the data inputted on one personal computer do not become effective in the case of using other personal computer.

[Patent document 1] Japanese Patent Application Laid-Open No. 10-254957 (Abstract, paragraphs 0038-0041) [Patent document 2] Japanese Patent Application Laid-Open No. 8-30414 (Abstract, paragraph 0009) [Patent document 3] Japanese Patent Application Laid-Open Invention, Preferred Embodiments of the Invention)

### SUMMARY OF THE INVENTION

The present invention was made in view of such problems of the prior arts. Namely, an object of the present invention lies in providing a technology capable of omitting a labor of inputting data in a general-purpose manner without depending on a program in the process of running, a Web site in the process of being browsed, a terminal in the process of being used, and so on.

For solving the aforementioned problems, the following means were adopted. Namely, the present invention is an information processing device comprising: a display control unit making a display device display a screen containing a data input box for data specified by data identifying information in accordance with definition information on the screen; a storage unit storing the data inputted to the data input box together with the data identifying information; and a control unit searching for the data corresponding to the data identifying information from the storage unit when having the screen displayed, and setting the searched data into the data input box specified by the data identifying information.

Herein, the display control unit makes the display device display the screen in accordance with the definition information of the screen. As the display control unit, for example, there is known Browser that displays a file of HTML or XML, etc. Further, what the data identifying information connotes is information for specifying the data inputted to the data input box, the data identifying information being, in the HTML or the XML, etc., defined by tags.

Moreover, the control unit searches for the data corresponding to the data identifying information from the aforementioned storage unit when displaying the screen, and sets the searched data into the data input box specified by the data identifying information.

By such components, the information inputted to the data input box in the past is displayed in the data input box when displaying this data input box next time.

The aforementioned information processing device may further comprise a receiving unit receiving the definition information, wherein the definition information may contain the data identifying information, and the control unit may search for the data by the data identifying information contained in the definition information received. As such a unit, for instance, there is known Browser accessing a Web site on the Internet.

Further, the present invention is a relay device relaying between a server and a terminal receiving, from the server on a network, definition information of a screen containing a data input box for data specified by data identifying information and transmitting the data inputted to the data input box to the server, and the relay device may be what comprises: a communication unit communicating with the server and the terminal via the network; a storage unit storing the data inputted to the data input box together with the data identifying information; and a control unit searching for the data corresponding to the data identifying information from the storage unit when transmitting to the terminal the definition information of the screen containing the data input box for the data specified by the data identifying information, and setting the searched data into the data input box.

Accordingly, this relay device saves the data inputted to the data input box on the terminal and transmitted to the server and, when displaying this data input box next time, has the data displayed in this data input box, which have been saved.

Further, the present invention is a server transmitting, to a terminal on a network, definition information of a screen containing a data input box for data specified by data identifying information and receiving the data inputted to the data input box from the terminal, and this server may be what comprises: a communication unit communicating with the terminal via the network; a storage unit storing the data inputted to the data input box together with the data identifying information; and a control unit searching for the data corresponding to the data identifying information from the storage unit when transmitting to the terminal the definition information of the screen containing the data input box for the data specified by the data identifying information, and setting the searched data into the data input box.

Accordingly, this server saves the data inputted to the data input box on the terminal in the past and received from the terminal, and has, when displaying this data input box next time, the data displayed in this data input box, which have been saved.

The storage unit may be stored with plural pieces of data inputted to the data input box in the past, and the control unit may set, into the data input box, one piece of data among the plural pieces of data, and may have the remaining data displayed as options in the vicinity of the input box.

Thus, when the screen is displayed on the terminal, the data are displayed in the data input box. Therefore, a type miss due to the inputting of the user can be reduced. It is noted that in case the user desires to select other data, it may be properly selected from the options.

The aforementioned information processing device, relay device or server may further comprise a determining unit determining a priority order of the data set into the data input box.

The aforementioned information processing device, relay device or server may further comprise a arrangement unit determining a data arrangement order of the data displayed as the options.

The aforementioned information processing device, relay device or server may further comprise an obtaining unit obtaining information for identifying a user, the storage unit may be stored with the data in a way that relates it to the information for identifying the user, and the control unit may search for the data corresponding to the data identifying information for every user.

The storage unit may be stored with plural pieces of data identifying information related to the data, and the control unit may search for the data by any one piece of data identifying information among the plural pieces of data identifying information. With this structure, the common data can be set into such a plurality of data input boxes that the data can be specified by different pieces of data identifying information.

Further, the present invention may also be a method by which a computer, other device, a machine, etc. executes any one of the aforementioned processes. Moreover, the present invention may also be a program for making a computer, other device, a machine, etc. actualize any one of the aforementioned functions. Still further, the present invention may be what such a program is recorded on a recording medium readable by computers, etc. These computers are, for example, the terminal, the relay device, or the server, etc. As explained above, according to the present invention, the data input by the user can be saved in a general-purpose manner without depending on the program in the process of running, the Web site in the process of being browsed, the terminal in the process of being utilized, and so on.

### DESCRIPTION OF THE DRAWINGS

FIG. 1 is a view of a system architecture of an information system in a first embodiment of the present invention,

FIG. 2 is a view showing a comparison between a display example of a conventional Web site and a display example of a Web site in the present information system,

FIG. 3 is an image view of a data saving process,

FIG. 4 is an image view showing a structure of a database 3,

FIG. 5 is a display example of a screen displayed on a terminal 1,

FIG. 6 is a display example on the terminal 1 and an example of HTML source data for actualizing the display thereof,

FIG. 7 is an example of data stored in the database 3,

FIG. 8 is a whole processing flow executed on a proxy server 2,

FIG. 9 is a flowchart (1) of a process executed on the proxy server 2 when transmitted to Browser on the terminal 1 from a distribution server 4,

FIG. 10 is a flowchart (2) of the process executed on the proxy server 2 when transmitted to Browser on the terminal 1 from the distribution server 4,

FIG. 11 is a flowchart (1) of a process executed on the proxy server 2 when transmitted to the distribution server 4 from Browser on the terminal 1,

FIG. 12 is a flowchart (2) of the process executed on the proxy server 2 when transmitted to the distribution server 4 from Browser on the terminal 1,

FIG. 13 is a modified example of the whole processes executed on the proxy server 2,

FIG. 14 is an example of a processing flow for displaying HTML for a form, etc. on the terminal 1,

FIG. 15 is a database update processing flow example (1),

FIG. 16 is a database update processing flow example (2).

### DETAILED DESCRIPTION OF THE INVENTION

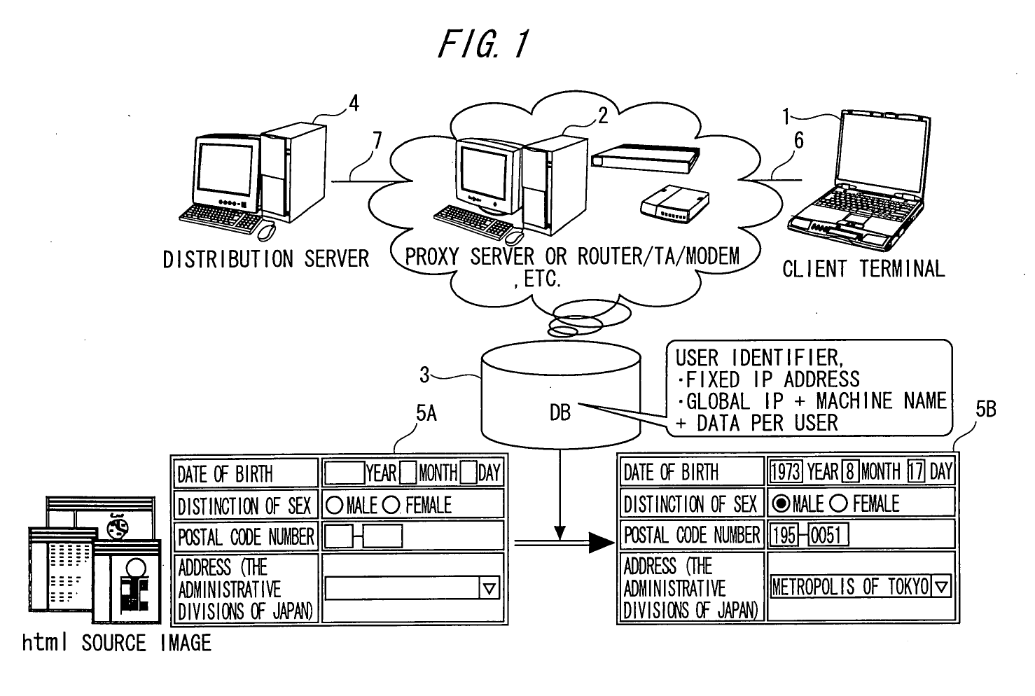

Preferred embodiments of the present invention will hereinafter be explained with reference to the drawings.

<<First Embodiment>> (Proxy Server System) An information system in an embodiment of the present invention will be described based on the drawings in FIGS. 1 through 13.

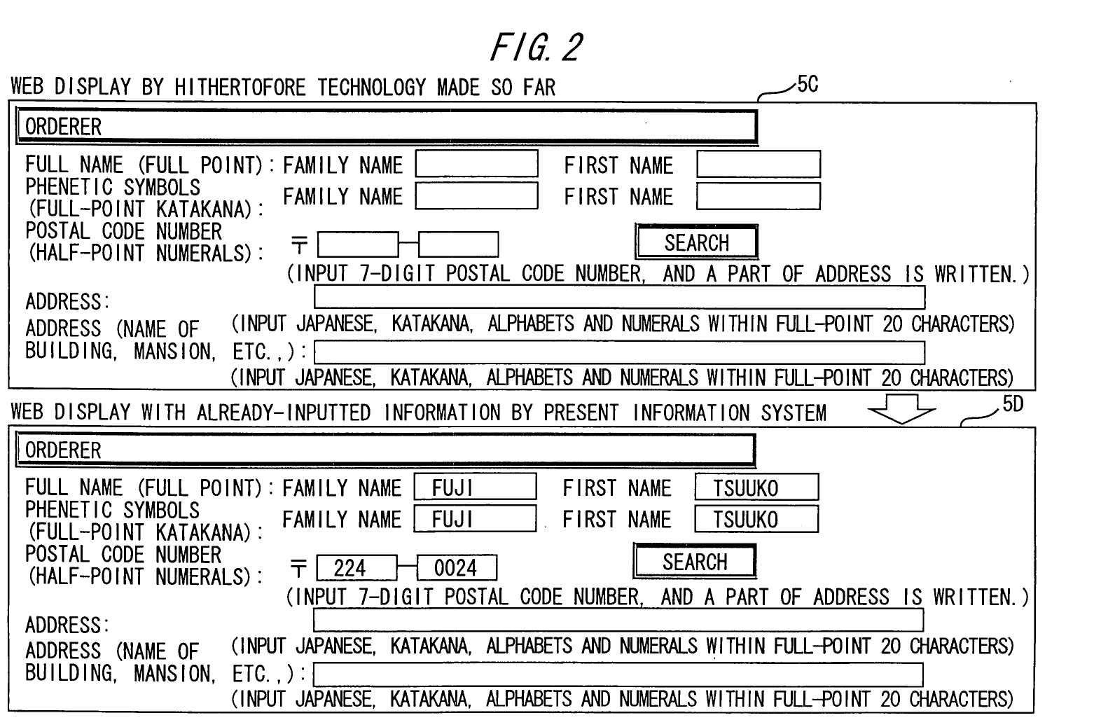

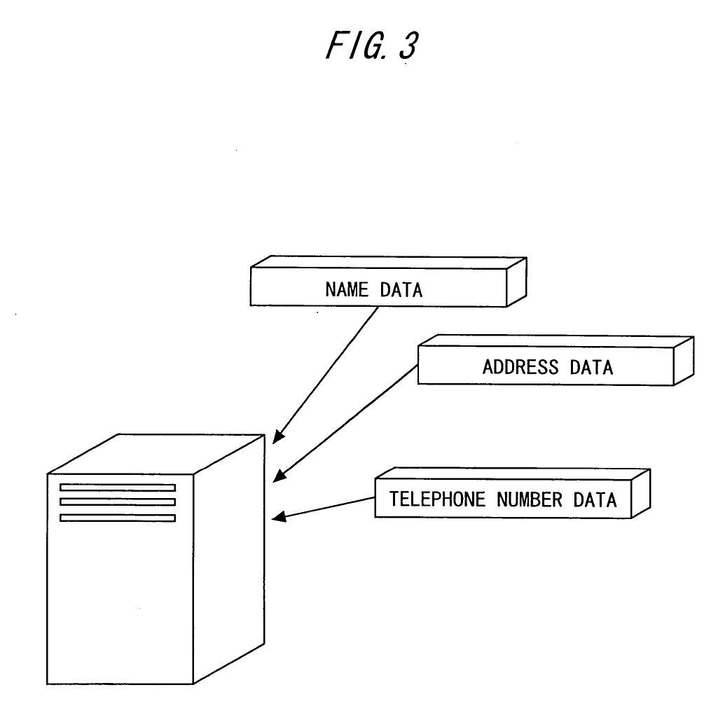

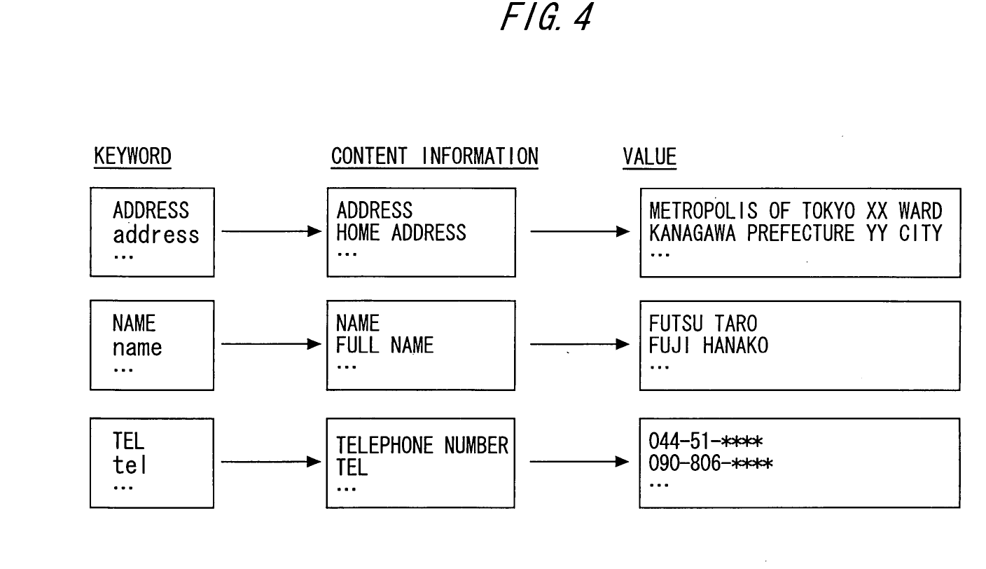

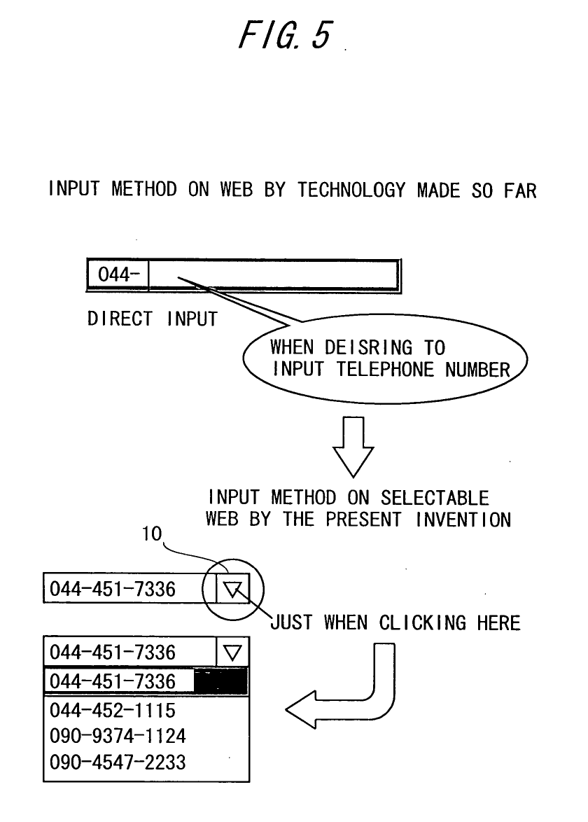

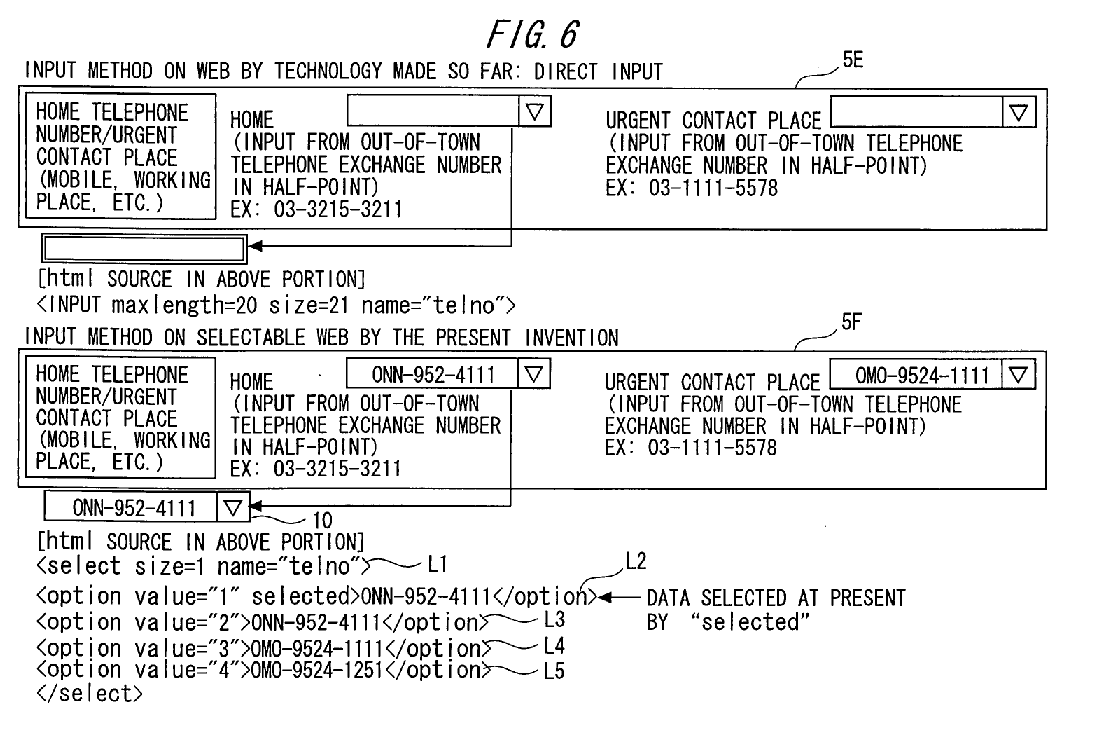

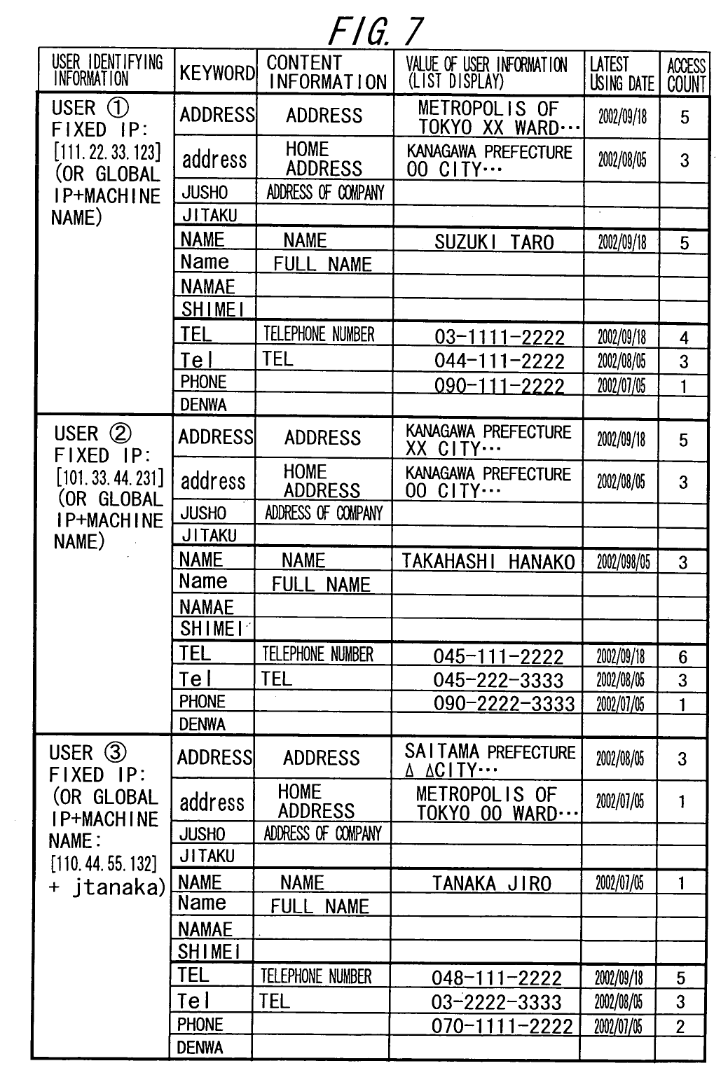

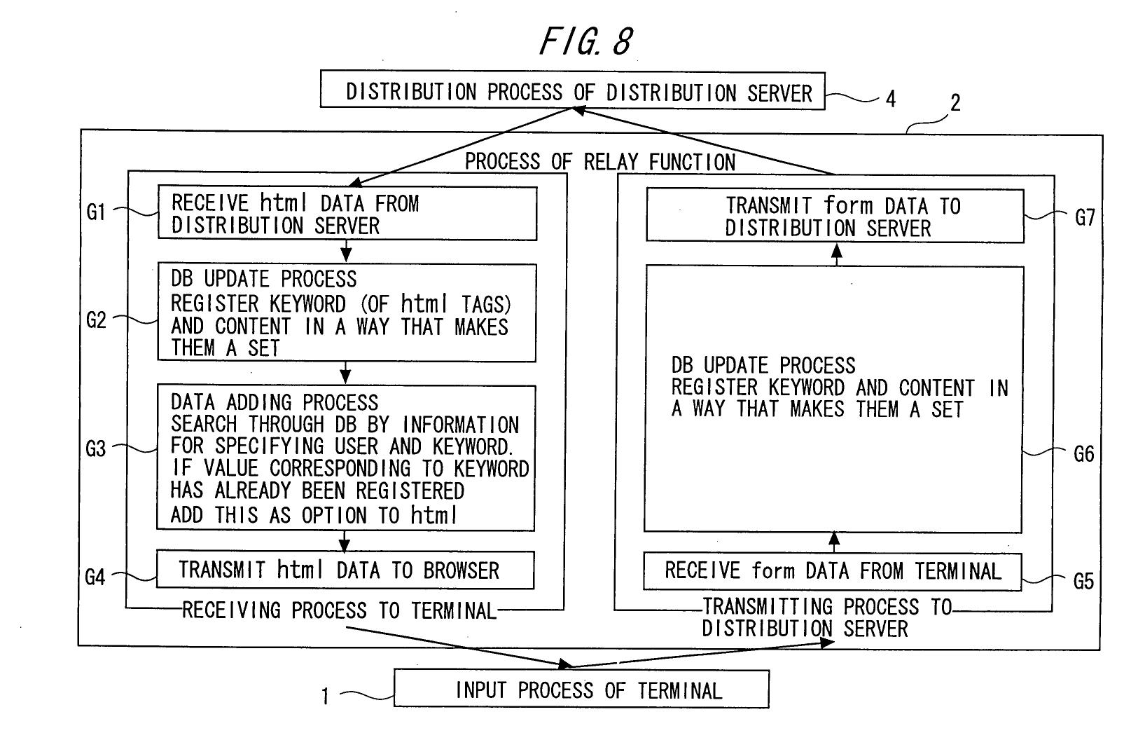

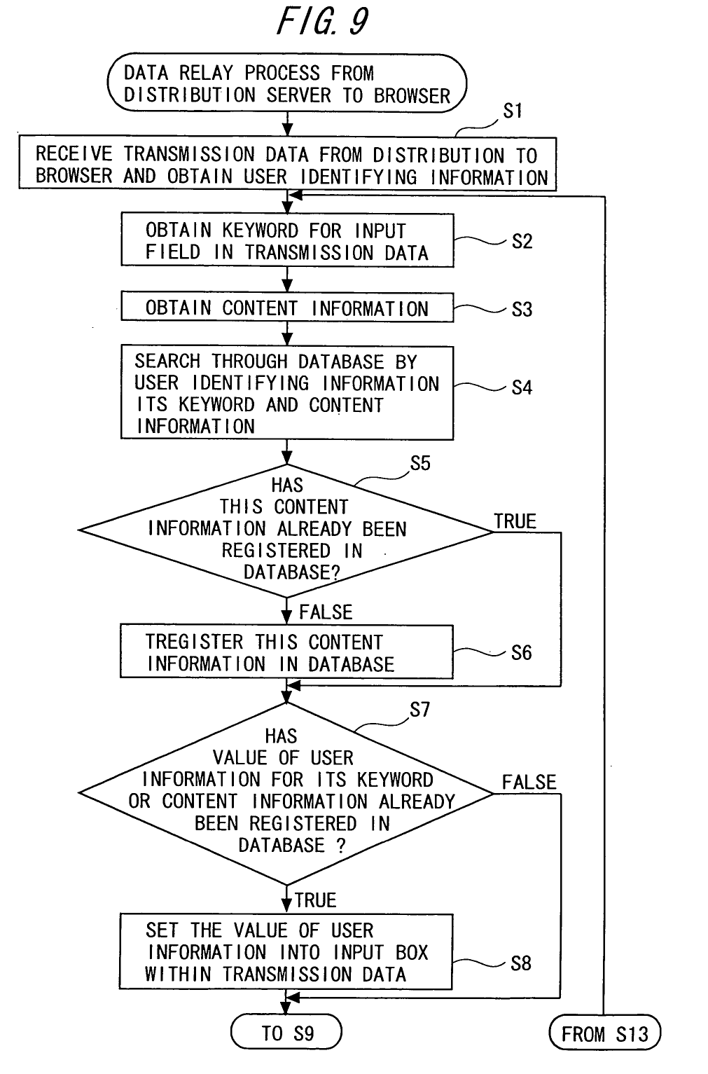

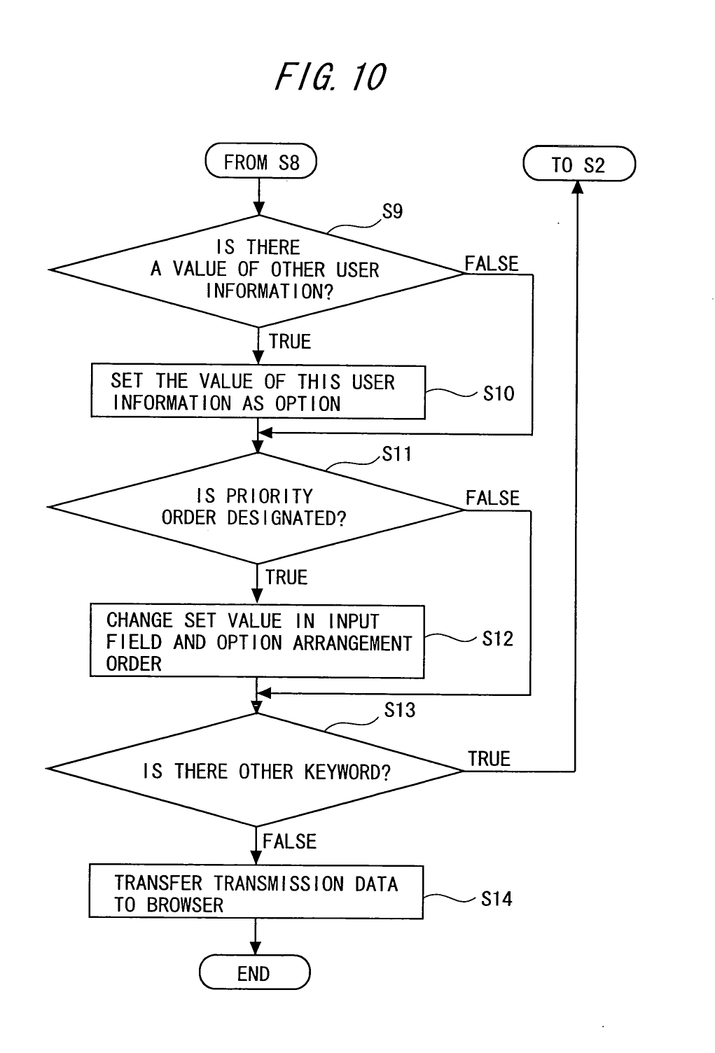

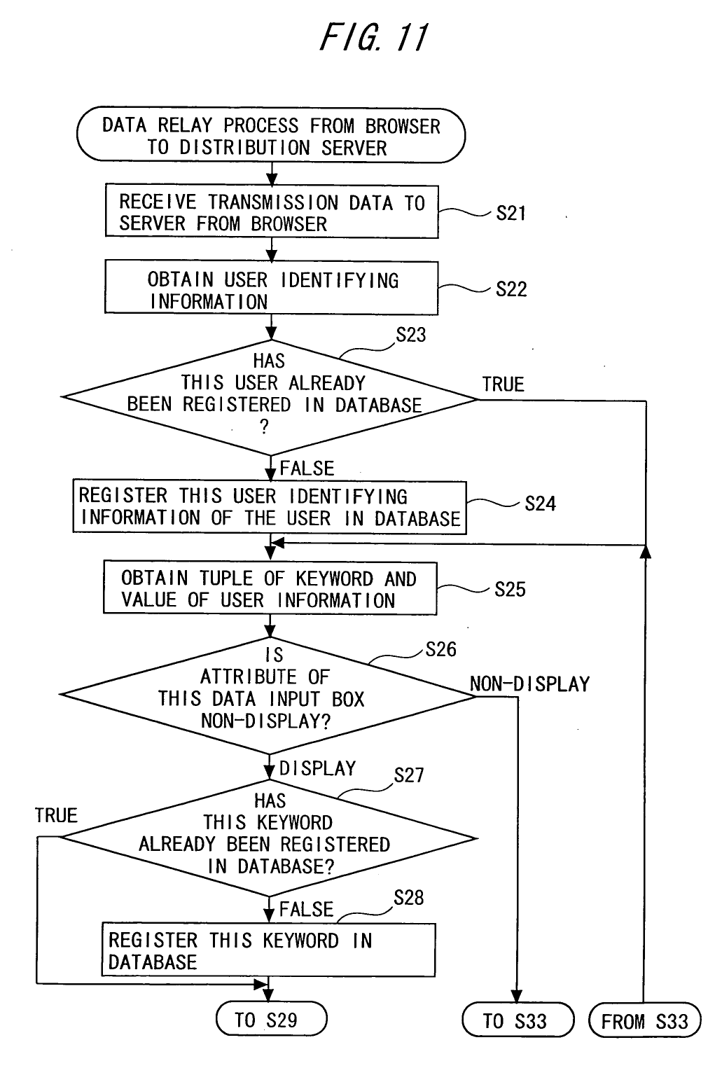

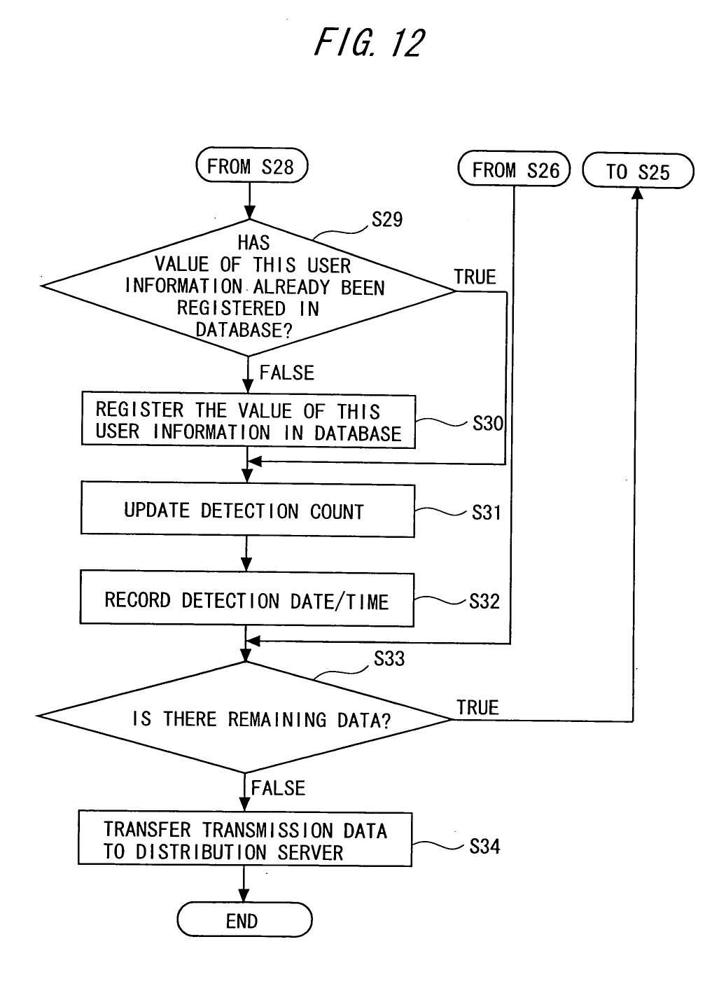

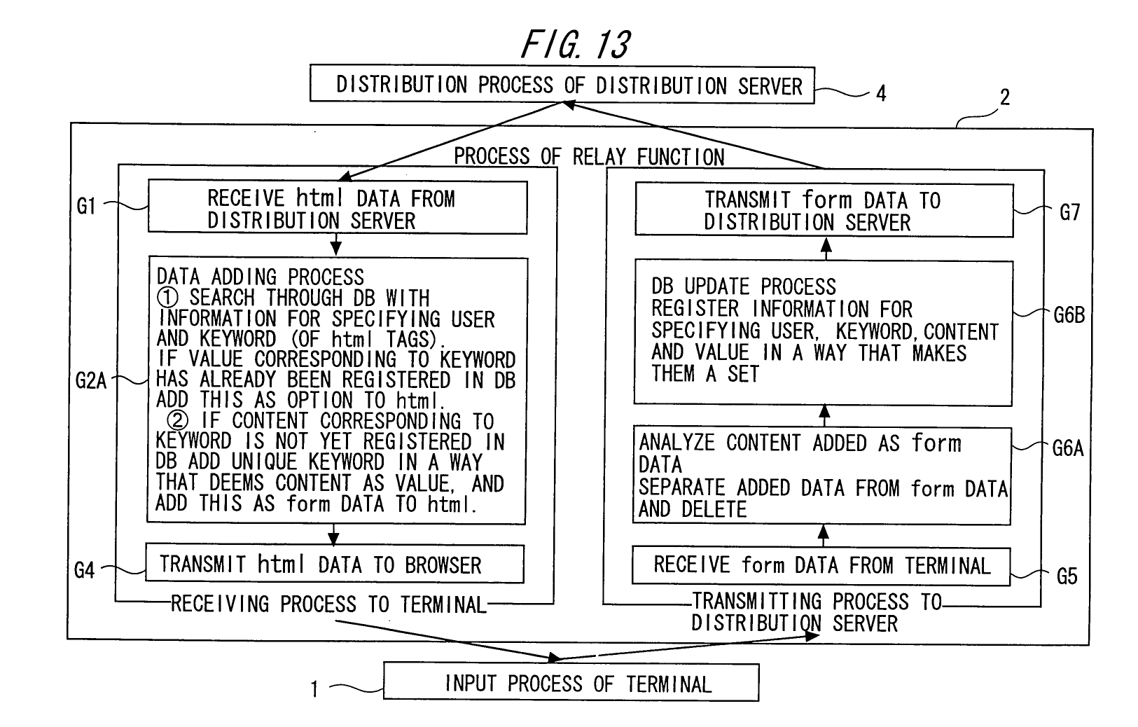

FIG. 1 is a view of a system architecture of this information system, FIG. 2 is a view showing a comparison between a display example of a conventional Web site and a display example of a Web site in this information system, FIG. 3 is an image view of a data saving process in the present information system, FIG. 4 is an image view showing a structure of a database 3 shown in FIG. 1, FIG. 5 is a display example of a screen displayed on a terminal 1 in FIG. 1, FIG. 6 is a display example on the terminal 1 and is also an example of HTML (HyperText Markup Language) source data for actualizing the display thereof, FIG. 7 is an example of data stored in the database 3, FIG. 8 is a whole processing flow executed on a proxy server 2 in FIG. 1, FIGS. 9 and 10 are flowcharts of a process executed on the proxy server 2 when transmitted to Browser on the terminal from a distribution server 4, FIGS. 11 and 12 are flowcharts of a process executed on the proxy server 2 when transmitting data to the distribution server 4 from Browser on the terminal 1, and FIG. 13 is a modified example of the whole processes executed on the proxy server 2.

<System Architecture>

FIG. 1 shows the view of the system architecture of the present information system. This information system includes the distribution server 4 for distributing information to the terminal 1 of a user, and a proxy server 2 for relaying between the terminal 1 and the distribution server 4.

The distribution server 4 and the proxy server 2 are a general type of computers having communication functions. The distribution server 4 distributes, based on HTTP (HyperText Transfer Protocol), the HTML source data to the terminal 1.

The proxy server 2 relays between a network 6 to which the user terminal 1 is connected and an external network 7. A device having the communication function of communicating with a plurality of networks (destinations of the communications) and a processing unit for executing programs, suffices as the proxy server 2. Accordingly, the proxy server 2 is not necessarily the general type of computer but may also be, for example, a router, a terminal adapter or a MODEM, etc.

The terminal 1 is a personal computer, PDA (Personal Digital (Data) Assistants), a cellular phone, PHS (Personal Handyphone System), a digital television, a set-top box and so on. The terminal 1 has a function as a client, accepts an input of the user, transmits it to the server (the proxy server 2, the distribution server 4, etc.) and provides the user with the information from the server.

As shown in FIG. 1, the proxy server 2 stores the data in the database 3 and can refer to the data stored therein. This database 3 may be a database built in the proxy server 2. The database 3 may also be, however, a database managed by a data server communicating with the proxy server 2 via the network.

The database 3 is recorded with an identifier (which will hereinafter be called user identifying information) for identifying the user or the terminal 1 used by the user, and with data (which will hereinafter be called a value of the user information) for every user that is stored in a way that uses the user identifying information as a key. The user identifying information is, for example, the IP address of the terminal 1.

In a case where the network 6 uses a private address independent of the external network 7, etc., however, a combination of, for example, an IP address of the proxy server 2 and a machine name (which is also called a node name and a computer name) of the terminal 1 may be used as the user identifying information. Further, a MAC address (Media Access Control address) possessed by an unillustrated communication board of the terminal 1 may also be used as the user identifying information.

In a multi-user environment where a plurality of users utilizes the terminal 1, a log-in name, etc. may be added to the aforementioned user identifying information.

A value of the user information is information inputted by the user in the past on the Web site. For instance, an input form 5A is exemplified in FIG. 1. This input form 5A contains input boxes for inputting a date of user's birth, a distinction of sex, a postal code number and an address.

When the user inputs data to this input form 5A and transmits it to the distribution server 4, the proxy server 2 reads the data and stores it in the database 3. Then, when this input foam 5A is to be distributed to the terminal 1 from the distribution server 4 next time, the proxy server 2 reads the data stored in the database 3 and sets the readout data in the input foam 5A. This being thus done, an input form 5B is displayed on the terminal 1 in a state where the data inputted in the past are set.

<Processing Outline in System>

FIG. 2 is the view showing the comparison between the display example on the conventional Web site and the display example on the Web site.

An input form 5C is displayed as a Web display example according to the prior art in an upper part in FIG. 2. Further, an input form 5D in which the values of the user information are set is displayed in a lower part in FIG. 2 by the present information system.

A user interface as seen on the input form 5C has hitherto been generally utilized as a means for making the user input the information on the Web. The input form 5C is displayed when having the user information inputted as at online shopping, etc. This input form 5C generally contains input boxes such as a name-in-Chinese-character box, a name-in-Katakana (Japanese character) box, a postal code number box, an address box, etc.

On the other hand, in the present information system, when this type of input form 5C is distributed to the terminal 1 from the distribution server 4, the proxy server 2 sets the values of the user information in the input box beforehand. The proxy server 2 transfers to the terminal 1 an input form 5D in which the values of the user information are set and has the input form 5D displayed.

These pieces of data are data which were inputted by the user in the past and have been saved in the database 3. Namely, the proxy server 2 monitors the data transmitted to the distribution server 4 from the terminal 1 and saves in the database 3 a piece of information for identifying each input box and a value (an input character string) set in this input box in a way that pairs up these pieces of information.

FIG. 3 is an image view of the data saving process in the present information system. The proxy server 2 identifies the values transmitted from the terminal 1 to the distribution server 4 as, for example, name data, address data, telephone number data, etc., and saves the thus identified values together with keywords specifying these identifications.

For such data identifications, for instance, in the case of the HTML-formatted source, name tags can be utilized. The information set in between the name tags functions as a data name when transferring the data set in the input box to the server from the client.

The name tags are, when defining the input box, used such as telephone number: <input maxLength=16 name=“tel”>. In this case, the data name in the data input box defined by this source is tel. In the present embodiment, the information for thus identifying the data is called a keyword.

On the other hand, the “telephone number:” is a display character string displayed on the screen. In the present embodiment, the information such as the display character string displayed on the screen of the client, is called content information.

If, for instance, a telephone number “99-9999-9999” is set in the input box defined by this source, the terminal 1 transmits the data name “tel” and the value “99-9999-9999” in a pair to a processing program (known as Common Gateway Interface (CGI)) of the distribution server 4.

The proxy server 2, when a page, e.g., a form containing the input boxes is transmitted to the terminal 1 from the distribution server 4, saves the information for identifying this terminal 1, the keyword specified by the name tags and the content information indicating the display character string thereof.

Next, the proxy server 2, when the input data set in the form are transmitted to the distribution server 4 from the terminal 1, detects the input data (values) together with the keyword and the content information described above, and saves these pieces of information in the database 3. This being thus done, the input data set in the past in the respective input boxes identified by the keywords, can be saved in connection with the terminal 1. In this case, the aforementioned values may be classified by the keywords or may be classified by the content information. Further, the values may also be classified by combinations of the keywords and the content information.

Those being thus classified, as shown in FIG. 3, the input data transmitted in the past to the distribution server 4 are classified and saved in the database 3. For example, the name data, the address data or the telephone number data, etc. are classified by the keywords and saved together with the content information.

Then, when the same input form is transmitted to the terminal 1 again from the distribution server 4, the proxy server 2 searches for the input data saved in connection with this terminal 1 by use of the keyword and the content information. Then, the proxy server 2 sets the searched input data in the input form and transfers it to the terminal 1. This being done, the form containing the input data transmitted in the past is displayed on the terminal 1.

FIG. 4 is an image view showing the structure of the database 3 shown in FIG. 1. The database 3 is stored with tuples of the keywords, the pieces of content information and the values. The keywords are, e.g., ADDRESS, NAME, TEL, etc. For the same data, however, there is a case where a keyword different on every Web site might be used.

The case is, for example, such that ADDRESS is used as a keyword for the address or that “address” is used as a keyword, and so on. Further, there might be a case where NAME is used as a keyword for the name and a case where “name” is used as a keyword. Moreover, TEL, “tel or “telephone” may be used for the telephone number.

Such being the case, in the present information system, the plurality of keywords are stored for one single user information value. Thus, the plurality of keywords are set for the single user information value, whereby the value can be set in common to the plurality of input boxes in which the same value, though the keywords are different, should be set.

For example, “address”, “home address”, etc are stored as the content information for the keywords such as “ADDRESS”, “address”, etc. Further, “. . . , XX Ward, the metropolis of Tokyo”, “. . . , YY City, Kanagawa Prefecture”, etc. are stored as the values for the tuples of the keywords and the pieces of content information. This is the case where the user of this terminal 1 has the addresses in two areas of the metropolis of Tokyo and Kanagawa Prefecture.

Further, “full name”, “name”, etc. are stored as the content information for the keywords such as “NAME”, “name”, etc. Moreover, “Futsu Taro”, “Fuji Hanako”, etc. are stored as the values for the tuples of these keywords and the pieces of content information. This is the case where the two users use this terminal 1.

<Example of Screen and Data Structure>

FIG. 5 is the display example of the screen displayed on the terminal 1. FIG. 5 exemplifies the input box for inputting the telephone number. In the conventional input form, the user inputs the telephone number such as 044xxxyyyy, etc. into the input box by use of a keyboard, etc.

Moreover, in the case of an auto complete function, when a predetermined number of characters such as 044 are inputted, a character string inputted in the past, of which the head is coincident with 044, is displayed as an option.

On the other hand, in the present information system, the proxy server 2 searches through the database 3, wherein the keyword (e.g., “tel”) as the value of the name tags is used as a key. Then, in case the value of the user information corresponding to this keyword is stored in the database 3, the proxy server 2 sets the value of the user information as it is into the input box.

Further, in case a plurality of databases 3 are stored with the values of the user information corresponding to that keyword, the proxy server 2 sets one value into the input box and displays the remaining values in an option format (an arrow 10 in FIG. 5). When the user clicks the arrow 10, the option is displayed, and hence the user is able to select a desired telephone number. This being done, it is possible to select the value different from the values of the user information which were set by the proxy server 2, and to set it into the input box.

In this case, there may be provided a priority showing which character string among those stored in the database 3 is given a priority of being set into the input box, or a mode setting menu for designating the order of displaying the options. It may be enough that, for example, [in the order from the latest], [in the order from the largest in the number of uses], [the order of numbers], [the order of alphabets], etc. are designated in the mode setting menu.

Note that the value of the user information may be searched for, wherein the tuple of the keyword and the content information is used as a key. Moreover, the value of the user information may also be searched for, wherein the content information is used as a key.

Further, when displaying the value of the user information in the input box, the proxy server 2 may change a display mode corresponding to the content information. For example, if the content information is “address”, what is proper as the address may be displayed. For instance, a character string that does not exist as an address is corrected and then displayed, and so forth.

Furthermore, in case the content information is “telephone number”, what is proper as a telephone number may be displayed. For example, predetermined digits are delimited by hyphens, and so on. Moreover, in the case of including a designation of “half-point” as the content information is “telephone number (half-point)”, it is confirmed whether the value is displayed in half-point numerals or not, and a correction is made, and so forth.

FIG. 6 is the example of the HTML source data for actualizing the display example on the terminal 1 and the display thereof. An input form 5E in FIG. 6 contains a display character string input box named “home”. The HTML source that defines this input box can be described such as, for example, <input max length=20 size=21 name=“telno”>.

An input form 5F into which the proxy server 2 adds character strings and options to the input form 5E described above, is shown in a lower part in FIG. 6. In this example, a telephone number “ONN-952-4111” is set in the “home” box, and further options indicated by an arrow 10 are added.

Thus, the HTML source on the screen where one character string is set and the remaining character strings are set as options, can be defined as L1 through L5 in the lower part in FIG. 6 are given.

“Select” tags shown in L1 specify the option in the input box. In this example, it is designated by a “size” attribute (size=1) that one option be displayed.

In L2 through L5, the respective options are defined by “option” tags. Moreover, it is designated by a “selected” attribute in L2 that this option be displayed in a pre-selected status.

Thus, the proxy server 2 shown in FIG. 1, when, e.g., the input form 5E is distributed to the terminal 1 from the distribution server 4, changes the form as into an input form 5F on the basis of the information set in the past on the terminal 1, and transfers it to the terminal 1.

FIG. 7 is the example of the data stored in the database 3. This database 3 retains, as a record, user identifying information for identifying the user, a keyword, content information, a value, the latest using date/time, an access count counted so far.

The user identifying information is information for identifying the user who sets the data in the form, etc. It has already been stated that, for instance, the IP (Internet Protocol address), etc. may be used as the user identifying information. The information in the database 3 is sorted out for every user on the basis of the user identifying information.

The keyword is a value set in the “name” tags and is a so-called data name. The content information is a display character string added to the input box on the form.

A value of the user information is an input character string set in the past by the user into the input box of the form. The latest using date/time is the latest date/time when the record concerned in the database 3 was accessed (written or read out) in the past. Further, the access count counted so far is a count of accesses to the record concerned in the database 3 in the past.

The value of the user information that was accessed latest can be discerned based on the latest using date/time among the plurality of values of the user information that can be specified by the user identifying information, the keywords and the content information. Further, what has a larger access count among the values of the plural pieces of user information specified by the user identifying information, the keyword and the content information, can be selected based on the access count.

<Processing of Proxy Server>

FIG. 8 shows the whole processing flow of the proxy server 2. With this processing, the proxy server 2 provides the function of relaying between the distribution server 4 and the terminal 1. What is assumed herein is a case in which the form containing the input box is defined by the HTML data and transmitted to the terminal 1 from the distribution server 4.

In this process, the proxy server 2, to start with, receives the HTML data from the distribution server 4 (G1). At this time, the proxy server 2 refers to destination information of the HTML data and acquires the user identifying information for specifying the user.

Next, the proxy server 2 executes an update process of the database 3 (G2). In this process, the keyword and the content information, which are specified by the HTML tags, are registered as a set of information.

Next, the proxy server 2 executes a data adding process (G3). In this process, the proxy server 2 searches through the database 3 on the basis of the user identifying information for specifying the user and the keyword. Then, if a value corresponding to the keyword has already been registered in the database 3, the proxy server 3 sets this value in the input box defined by the HTML. Further, if a plurality of values have already been registered, these values are added as options to the HTML.

Next, the proxy server 2 transmits the HTML data to the Browser (G4). The terminal 1 displays the form on the screen and waits for a user's input. Then, the terminal 1 transmits, together with the keyword, a value (which will hereinafter be referred to as a value of the user information) inputted to the form by the user to the distribution server 4. Note that a set of values in the plurality of input boxes contained in one form are called form data.

Thereupon, the proxy server 2 receives the form data transmitted to the distribution server 4 from the terminal 1 (G5). Then, the proxy server 2 executes a database update process (G6). Herein, the proxy server 2 sorts out the values (inputted to the form by the user) of the user information on the basis of the user identifying information for specifying the user and the keyword, and registers these values.

Thereafter, the proxy server 2 transmits the aforementioned form data to the distribution server 4 (G7). FIGS. 9 through 12 show flowcharts of detailed processes executed in the proxy server 2. These processes are actualized by a computer program executed by a CPU of the proxy server 2.

FIGS. 9 through 10 show the process executed in the proxy server 2 when transmitting data to the Browser on the terminal 1 from the distribution server 4. This process is a process of setting the value of the user information in the input form, etc. transmitted to the Browser on the terminal 1 from the distribution server 4.

In this process, to begin with, the proxy server 2 receives transmission data transmitted to the Browser on the terminal 1 from the distribution server 4 (S1). At this time, the proxy server 2 acquires the user identifying information.

Next, the proxy server 2 obtains a keyword for the information (for example, the name tags) structuring the input box within the transmission data (S2). Next, the proxy server 2 acquires the content information as a display character string displayed in the content (S3).

Next, the proxy server 2 searches through the database 3 by use of the user identifying information, the keyword and the content information (S4). Then, the proxy server 2 judges whether or not the content information for this keyword is registered in the database 3 (S5).

If the content information for this keyword is not registered, the proxy server 2 registers this piece of content information in the database 3 (S6).

Next, the proxy server 2 judges whether or not the value of the user information for this keyword has already been registered in the database 3 (S7). If the value of the user information for this keyword has been registered, the proxy server 2 sets this value in the input box within the transmission data (S8).

Next, the proxy server 2 judges whether or not a value of other user information for this keyword is registered in the database 3 (S9 in FIG. 10). Then, if the value of other user information is registered, the value of this piece of user information is set as an option (S10). In this case, if a plurality of other character strings are registered, options corresponding to the number thereof are created.

Next, the proxy server 2 judges whether a priority order for the values set in the input box and a priority order for an option arrangement order, are designated or not (S11). Then, in case the priority order is set, the values set in the input box are changed according to this priority order. Further, the option arrangement order is changed according to that priority order (S12).

In this case, the priority order for the set values in the input box and the priority order for the option arrangement order, may be set in common. For instance, the values structuring the set values in the input box and the options are set as series of data and arranged according to an alphabetic order or an updated detection date/time order, and so on.

Further, these priority orders may also be made different. For example, as for the priority order for the set values in the input box, the priority is given to what is the latest, and, as for the options, the remaining values may be arranged in the alphabetic order.

Next, the proxy server 2 judges whether or not there is other keyword in the transmission data received in S1 (S13). If there is other keyword, the proxy server 2 returns the control to S2. While on the other hand, if there is no other keyword, the proxy server 2 transfers the transmission data to the Browser on the terminal 1 (S14), and terminates the processing.

FIGS. 11 and 12 show a process executed in the proxy server 2 when transmitting data to the distribution server 4 from the Browser on the terminal 1.

In this process, at first, the proxy server 2 receives the transmission data transmitted to the distribution server 4 from the Browser on the terminal 1 (S21).

Next, the proxy server 2 obtains the user identifying information (see FIG. 7) from the transmission data (S22). Then, the proxy server 2 judges whether this user has already been registered in the database 3 or not (S23).

In case the user is not registered in the database 3, the proxy server 2 registers the user identifying information of this user in the database 3 (S24).

Next, the proxy server 2 obtains the tuple of the keyword and the value of the user information from the transmission data (S25). Herein, the keyword is a keyword indicating the data in the input box, for example, a value set in the name tags. Further, the value of the user information is a value set by the user in the input box.

Next, the proxy server 2 judges whether a display attribute of the value in the data input box that is designated by this keyword, is non-display or not (S26). An implication that the display attribute is non-display is that the information inputted by the user is not displayed as in a password input box or the information is displayed in the way of being replaced with other character string such as asterisks (*), etc. In case the display attribute is the non-display, the proxy server 2 advances the control to S33 (see FIG. 12).

While on the other hand, in case the display attribute is not the non-display, further, the proxy server 2 judges whether or not that keyword has already been registered in the database 3 (S27). Then, in case the keyword is not registered in the database 3, the proxy server 2 registers this keyword in the database 3 (S28).

Next, the proxy server 2 judges whether or not the value of the user information has already been registered together with the keyword in the database 3 (S29 in FIG. 12). If the value of the user information is not registered in the database 3, the proxy server 2 registers the value of the user information in the database 3 (S30). Further, the proxy server 2 updates a detection count of the tuple of the keyword and the input character string (S31).

Next, the proxy server 2 records a detection date/time of the keyword and the input character string (S32). Then, the proxy server 2 judges whether or not there are remaining data (the keyword and the value of the user information) in the transmission data received in S1 (S33). If there are the remaining data, the proxy server 2 returns the control to S25. If there are not the remaining data, the proxy server 2 transmits the transmission data to the distribution server 4 (S34), and terminates the processing.

As described above, according to the present information system, the value inputted in the past by the user is set in the input box in the form distributed to the terminal 1 from the distribution server 4. This value is specified by the keyword as in the name tags of the HTML, etc, and is accumulated in the database 3. Accordingly, as far as the keyword is coincident, the value can be set beforehand even in the case of a form on a Web site to which the user gains an access for the first time.

Further, according to the present information system, as shown in FIG. 6, one of the values of the user information is already set before the user starts a key input. Therefore, an input of a head character is not required for setting the value, and hence a type miss can be prevented. Note that if the user desires to select other value, the user may be prompted to display the options and may select a desired item.

Moreover, according to the present information system, the value is set in the construction element such as the proxy server 2, etc. other than the terminal 1. Hence, even in case the user changed the terminal 1 to other type of device, the values inputted in the past can be effectively utilized. Further, even if the user uses a plurality of terminals 1 in combination, the values inputted on the one single terminal 1 can be effectively utilized on other terminal 1.

Further, according to the present information system, it is possible to designate the priority order of the values set in the input box and the option arrangement order in the form.

Moreover, according to the present information system, the non-display information such as the password, etc. is neither saved in the database 3 nor set in the data input box. Therefore, even if the plurality of users uses one terminal 1 in common, this hinders neither ensuring the security of the user's individual information nor safeguarding the privacy. Note that there may be provided in this case the mode setting menu for prompting the user to select whether the non-display information is saved or not, and it may be determined based on this setting whether to be saved or not.

<Modified Example of Content Information Registration Process>

In the embodiment described above, when distributing the form to the Browser from the distribution server 4, the proxy server 2 detects the display character string on the form as the content information and stores it in the database 3. As a substitute for this, for instance, when distributing the form to the Browser from the distribution server 4, the proxy server 2 may incorporate the display character string on the form into the HTML tags structuring the form.

Namely, the display character string may be incorporated as a value for the unique name tags. The unique name tags may be generated by combining the user identifying information with, for instance, a predetermined special character string.

The Browser, when transmitting the information set in the form to the distribution server 4, transmits the value in the unique name tags in a way that incorporates it together with the value in other input box into the form data. Such being the case, the proxy server 2 may detect a unique keyword and a value for this keyword from within the form data.

FIG. 13 shows an outline of this process. In this process, the proxy server 2, at first, receives the HTML data from the distribution server 4 (G1).

Next, the proxy server 2 executes an update process of the database 3 (G2A). In this process, the proxy server 2 obtains the user identifying information for identifying the user from the information received. Further, the proxy server 2 obtains the keyword defined in the HTML name tags. Then, the proxy server 2 searches through the database 3 by use of the user identifying information and the keyword. Then, if the value of the user information for this keyword has already been registered in the database 3, this value is set in the input box.

Moreover, if the content information (the display character string) for the keyword is not yet registered in the database 3, a unique keyword is added and a value of the content information as a value is incorporated into the name tags of the HTML data.

Next, the proxy server 2 transmits the HTML data to the Browser (G4). The Browser extracts the value from the name tags of the unique keyword, incorporates it together with a value in other input box, and transmits it to the distribution server 4.

The proxy server 2 receives the form data transmitted to the distribution server 4 from the terminal 1 (G5). Then, the proxy server 2 analyzes the form data, obtains the content information fort the keyword added in the process in G2A, and deletes it from the form data (G6A).

Next, the proxy server 2 executes a database update process (G6B). Herein, there are registered a tuple of the user identifying information for specifying the user, the content information obtained in G6A and the value (the value inputted in the form by the user) of the user information.

Thereafter, the proxy server 2 transmits the form data to the distribution server 4 (G7).

<Other Modified Examples>

In the embodiment described above, each of the records of the database 3 contains the user identifying information, the keyword, the content information, the value, the latest using date/time and the access count counted so far. The embodiment of the present invention is not, however, limited to this record structure. In short, it may be sufficient that there can be saved the plurality of values classified by the tuple of the user identifying information, the keyword and the content information. Therefore, for instance, the plurality of keywords, the plural pieces of content information, the plurality of values may be linked to one piece of user identifying information. Further, these items of information may also be stored in an XML (extensible Markup Language) format.

In the embodiment described above, the proxy server 2, there has been explained the system in which the proxy server 2 presets the values in the form transmitted to the Browser on the terminal 1 from the distribution server 4. The embodiment of the present invention is not, however, limited to this architecture.

For example, the processes as shown in FIGS. 8 through 13 may be actualized as a program of the distribution server 4. In this case, in the distribution server 4, the aforementioned processes may be actualized as a program that intermediates between a Web server on the distribution server 4 and the Browser on the terminal 1. Further, the processes may be actualized as functions of a Web server program.

Further, the processes as shown in FIGS. 8 through 13 may be actualized as a program on the terminal 1. In this case, the processes may be actualized as the program that intermediates between the Browser on the terminal 1 and the Web server on the distribution server 4. Moreover, the processes described above may be actualized as functions of the Browser.

In the embodiment described above, the values of the user information which are set in the input box, are classified by the keyword stored in the name tags and stored in the database 3. Then, when the form is distributed, the proxy server 2 searches for the value of the user information by use of the keyword. The embodiment of the present invention is not, however, limited to this procedure.

For instance, the database 3 may be searched through by use of, in addition to the keyword stored in the name tags, the content information (the display character string) on the content. In this case, the search may be done using an AND condition of the keyword and the content information or an OR condition thereof. Moreover, the search may also be done using the content information without depending on the keyword. In any case, according to the present information system, the value of the user information can be set based on the keyword or the content information.

<<Second Embodiment>> (Setting on Terminal Side)

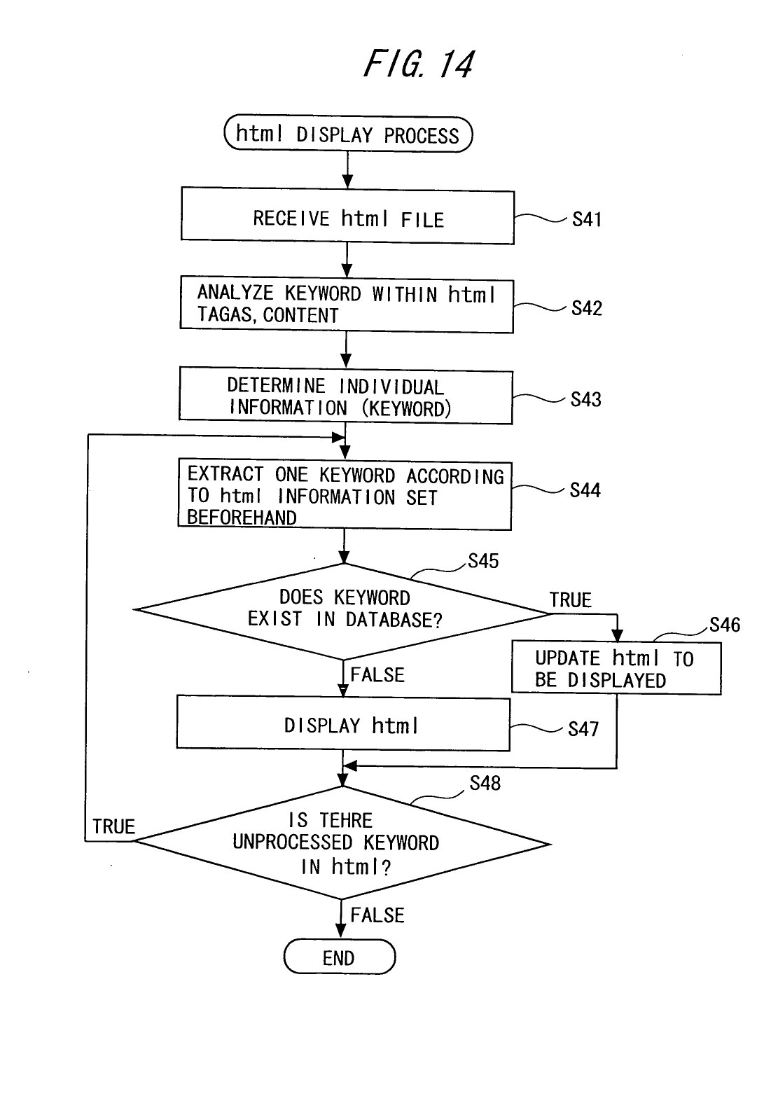

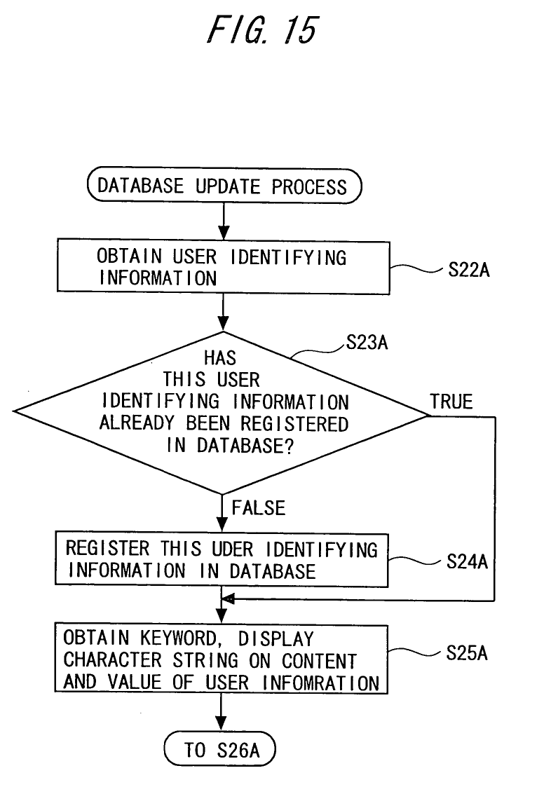

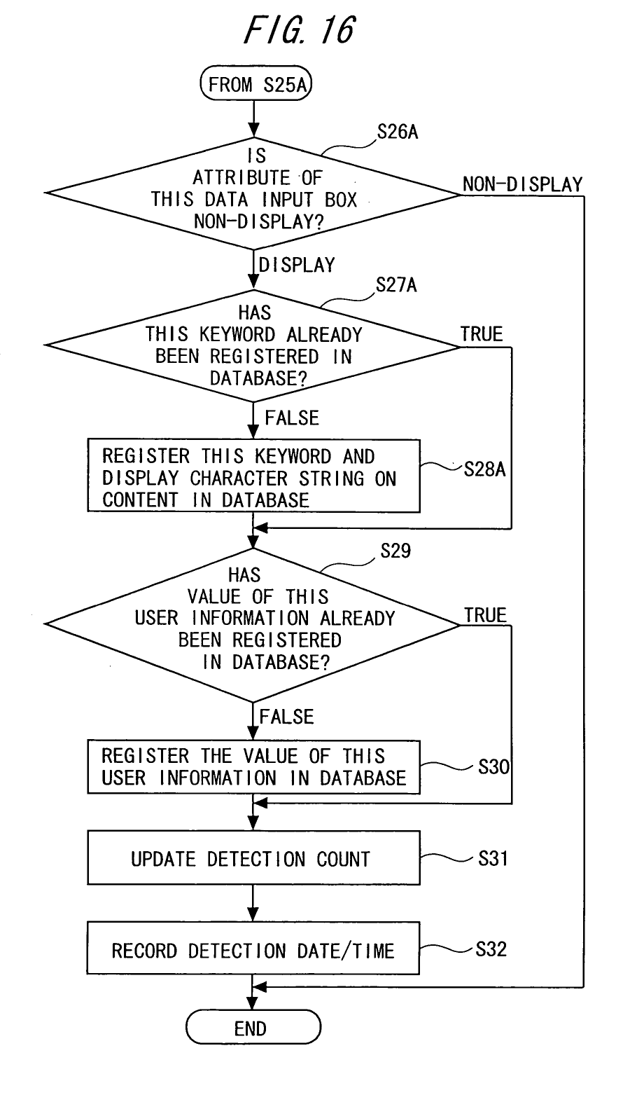

A second embodiment of the present invention will hereinafter be explained on the basis of the drawings in FIGS. 14 through 16. FIG. 14 is an example of a processing flow for displaying the HTML for the form, etc. on the terminal 1. FIGS. 15 and 16 are an example of a database update processing flow on the terminal 1.

In the first embodiment, there was explained the process of setting the value of the user information in the input box of the form, etc. in the proxy server 2. Moreover, it was explained that the processes in the first embodiment might be actualized as the program to be executed on the distribution server 4 or the terminal 1.

In this embodiment, among those processes, there will be explained a processing example of setting the value of the user information in the input box of the form, etc. by the program on the terminal. Other components and operations in this embodiment are the same as those in the first embodiment. Such being the case, the same components or processes are marked with the same symbols as those in the first embodiment, and their descriptions are omitted. Further, the drawings in FIGS. 1 through 13 will be referred to according to the necessity.

FIG. 14 shows the example of the process of displaying the HTML for the form, etc. In this process, the terminal 1 at first receives the HTML data (S41). At this time, the user identifying information for identifying the user is obtained.

Next, the terminal 1 analyzes the tags, the keyword, the content information, etc. of the HTML data received (S42). Then, the terminal 1 determines the individual keyword, content information, etc.

Then, the terminal 1 extracts one keyword from the HTML data (S44). Then, the terminal 1 judges whether or not the keyword is saved in the database with respect to the user of the user identifying information (S45). Note that this database has the same structure as the database 3 in the first embodiment has.

If this keyword exists in the database, the terminal 1 refers to the value of the user information for this keyword and updates the HTML data to be displayed (S46). Then, the terminal 1 displays the HTML data.

Next, the terminal 1 judges whether or not an unprocessed keyword exists in the HTML (S48). If the unprocessed keyword exists in the HTML, the terminal 1 returns the control to S44. While on the other hand, if the unprocessed keyword does not exist in the HTML, the terminal 1 terminates the processing.

FIGS. 15 and 16 show an example of a database update processing flow in the terminal 1. In this process, the terminal 1 at first obtains the user identifying information for identifying the user (S22A). Herein, the user identifying information is a log-in name, etc. of the user on the terminal 1. Then, the terminal 1 judges whether this user has already been registered in the database or not (S23A).

If the user is not registered in the database, the terminal 1 registers the user identifying information of this user in the database (S24A).

Next, the terminal 1 obtains the keyword, the display character string on the content and the value of the user information from the transmission data (S25A).

Next, the terminal 1 judges whether the display attribute of the value in the data input box that is specified by that keyword, is a non-display or not (S26A). If the display attribute is the non-display, the terminal 1 terminates the processing.

While on the other hand, if the display attribute is not the non-display, further, the terminal 1 judges whether or not this keyword has already been registered in the database (S27A). Then, if the keyword is not registered in the database, the terminal 1 registers this keyword in the database (S28A). The processes from this onwards are the same as those in FIG. 12 in the first embodiment, and hence their explanations are omitted.

As described above, according to this embodiment, the processes explained in the first embodiment can be actualized as the program on the terminal 1. This means that these processes may be incorporated into, for example, the Browser on the terminal 1.

<<Readable-by-Computer Recording Medium>>

The program for making a computer actualize any one of the aforementioned functions can be recorded on a readable-by-computer recording medium. Then, the computer is made to read and execute the program on this recording medium, whereby this function can be provided.

Herein, the readable-by-computer recording medium connotes recording mediums capable of accumulating information such as data, programs, etc. electrically, magnetically, optically and mechanically or by chemical action, which can be read from the computer. What is demountable out of the computer among those recording mediums may be, e.g., a flexible disk, a magneto-optic disk, a CD-ROM, a CD-R/W, a DVD, a DAT, an 8 mm tape, a memory card, etc.

Further, a hard disk, a ROM (Read Only Memory) and so on are given as recording mediums fixed to the computer.

<<Data Communication Signal Embodied in Carrier Wave>>

Furthermore, the program can be stored in the hard disk and the memory of the computer, and distributed to other computers via communication media. In this case, the program is transmitted as data communication signals embodied in carrier waves via the communication media. Then, the computer to which the program has been distributed can be made to provide the function.

Herein, the communication media may be any one of cable communication mediums, for example, metallic cables including a coaxial cable and a twisted pair cable, optical communication cables, etc., or wireless communication media, e.g., satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. An information processing device comprising:
a display control unit causing a display device display a screen containing a data input box for data specified by data identifying information in accordance with definition information on the screen;
a storage unit storing the data inputted to the data input box together with the data identifying information; and
a control unit searching for the data corresponding to the data identifying information from the storage unit when having the screen displayed, and setting the searched data into the data input box specified by the data identifying information.

2. An information processing device according to claim 1 further comprising a receiving unit receiving the definition information, wherein the definition information contains the data identifying information, and the control unit searches for the data by the data identifying information contained in the definition information received.

3. An information processing device according to claim 1, wherein the storage unit is stored with plural pieces of data inputted to the data input box in the past, and the control unit sets, into the data input box, one piece of data among the plural pieces of data, and has the remaining data displayed as options in the vicinity of the input box.

4. An information processing device according to claim 3 further comprising a determining unit determining a priority order of the data set into the data input box.

5. An information processing device according to claim 3 further comprising means for determining a data arrangement order of the data displayed as the options.

6. An information processing device according to claim 1 further comprising an obtaining unit obtaining information for identifying a user, wherein the storage unit is stored with the data in a way that relates the data to the information for identifying the user, and the control unit searches for the data corresponding to the data identifying information for every user.

7. An information processing device according to claim 1, wherein the storage unit is stored with plural pieces of data identifying information related to the data, and the control unit searches for the data by any one piece of data identifying information among the plural pieces of data identifying information.

8. A relay device relaying between a server and a terminal receiving, from the server on a network, definition information of a screen containing a data input box for data specified by data identifying information and transmitting the data inputted to the data input box to the server, comprising:
a communication unit communicating with the server and the terminal via the network;
a storage unit storing the data inputted to the data input box together with the data identifying information; and
a control unit searching for the data corresponding to the data identifying information from the storage unit when transmitting to the terminal the definition information of the screen containing the data input box for the data specified by the data identifying information, and setting the searched data into the data input box.

9. A relay device according to claim 8, wherein the storage unit is stored with plural pieces of data inputted to the data input box in the past, and the control unit sets one piece of data among the plural pieces of data into said data input box and adds to the definition information a piece of information for having the remaining data displayed as options in the vicinity of the input box.

10. A relay device according to claim 9 further comprising a determining unit determining a priority order of the data set into the data input box.

11. A relay device according to claim further comprising an arrangement unit determining a data arrangement order of the data displayed as the options.

12. A relay device according to claim 8 further comprising an obtaining unit obtaining information for identifying a user of the terminal, wherein the storage unit is stored with the data in a way that relates the data to the information for identifying the user, and the control unit searches for the data corresponding to the data identifying information for every user.

13. A relay device according to claim 8, wherein the storage unit is stored with plural pieces of data identifying information related to the data, and the control unit searches for the data by any one piece of data identifying information among the plural pieces of data identifying information.

14. A server for transmitting, to a terminal on a network, definition information of a screen containing a data input box for data specified by data identifying information and receiving the data inputted to the data input box from the terminal, comprising:
a communication unit communicating with the terminal via the network;
a storage unit storing the data inputted to the data input box together with the data identifying information; and
a control unit searching for the data corresponding to the data identifying information from the storage unit when transmitting to the terminal the definition information of the screen containing the data input box for the data specified by the data identifying information, and setting the searched data into the data input box.

15. A server according to claim 14, wherein the storage unit is stored with plural pieces of data inputted to the data input box in the past, and the control unit sets one piece of data among the plural pieces of data into said data input box and adds to the definition information a piece of information for having the remaining data displayed as options in the vicinity of the input box.

16. A server according to claim 15 further comprising a determining unit determining a priority order of the data set into the data input box.

17. A server according to claim 15 or 16 further comprising an arranging unit determining a data arrangement order of the data displayed as the options.

18. A server according to claim 14 further comprising an obtaining unit obtaining information for identifying a user of the terminal, wherein the storage unit is stored with the data in a way that relates the data to the information for identifying the user, and the control unit searches for the data corresponding to the data identifying information for every user.

19. A server according to claim 14, wherein the storage unit is stored with plural pieces of data identifying information related to the data, and the control unit searches for the data by any one piece of data identifying information among the plural pieces of data identifying information.

20. An information display method comprising the steps of:
causing a display device display a screen containing a data input box for data specified by data identifying information in accordance with definition information on the screen;
storing the data inputted to the data input box together with the data identifying information;
searching for the data corresponding to the data identifying information from the storage unit when having the screen displayed; and
setting the searched data into the data input box specified by the data identifying information.

21. An information display method according to claim 20 further comprising receiving the definition information, wherein the definition information contains the data identifying information, and in the searching step the data is searched for by the data identifying information contained in the definition information received.

22. An information display method according to claim 20, wherein, in the storing step, plural pieces of data inputted to the data input box in the past are stored, and in the setting step one piece of data among the plural pieces of data is set into the data input box, and the remaining data are displayed as options in the vicinity of the input box.

23. An information display method according to claim 23 further comprising determining a priority order of the data set into the data input box.

24. An information display method according to claim 22 or 23 further comprising a step of determining a data arrangement order of the data displayed as the options.

25. An information display method according to claim 20 further comprising obtaining information for identifying a user, wherein in the storing step the data is stored in a way that relates the data to the information for identifying the user, and in the searching step the data corresponding to the data identifying information for every user is searched for.

26. An information display method according to claim 20, wherein, in the storing step, plural pieces of data identifying information related to the data are stored, and in the searching step the data is searched for by any one piece of data identifying information among the plural pieces of data identifying information.

27. A communication method of relaying between a server and a terminal for receiving, from the server on a network, definition information of a screen containing a data input box for data specified by data identifying information and transmitting the data inputted to the data input box to the server, comprising the steps of:
communicating with the server and the terminal via the network;
storing the data inputted to the data input box together with the data identifying information;
searching for the data corresponding to the data identifying information from the storage unit when transmitting to the terminal the definition information of the screen containing the data input box for the data specified by the data identifying information; and
setting the searched data into the data input box.

28. A communication method of transmitting, to a terminal on a network, definition information of a screen containing a data input box for data specified by data identifying information and receiving the data inputted to the data input box from the terminal, comprising the steps of:
communicating with the terminal via the network;
storing the data inputted to the data input box together with the data identifying information;
searching for the data corresponding to the data identifying information from a storage unit when transmitting to the terminal the definition information of the screen containing the data input box for the data specified by the data identifying information; and
setting the searched data into the data input box.

29. A program making a computer execute the steps of:
making a display device display a screen containing a data input box for data specified by data identifying information in accordance with definition information on the screen;
storing the data inputted to the data input box together with the data identifying information;
searching for the data corresponding to the data identifying information from the storage unit when having the screen displayed; and
setting the searched data into the data input box specified by the data identifying information.

30. A program according to claim 29 making a computer further execute receiving the definition information, wherein the definition information contains the data identifying information, and in the searching step the data is searched for by the data identifying information contained in the definition information received.

31. A program according to claim 29, wherein, in the storing step, plural pieces of data inputted to the data input box in the past are stored, and in the setting step one piece of data among the plural pieces of data is set into the data input box, and the remaining data are displayed as options in the vicinity of the input box.

32. A program according to claim 31 making a computer further execute determining a priority order of the data set into the data input box.

33. A program according to claim 31 making a computer further execute determining a data arrangement order of the data displayed as the options.

34. A program according to claim 29 making a computer further execute obtaining information for identifying a user, wherein in the storing step the data is stored in a way that relates the data to the information for identifying the user, and in the searching step the data corresponding to the data identifying information for every user is searched for.

35. A program according to claim 29, wherein, in the storing step, plural pieces of data identifying information related to the data are stored, and in the searching step the data is searched for by any one piece of data identifying information among the plural pieces of data identifying information.

36. A program causing a computer relay between a server and a terminal receiving, from the server on a network, definition information of a screen containing a data input box for data specified by data identifying information and transmitting the data inputted to the data input box to the server, comprising the steps of:
communicating with the server and the terminal via the network;
storing the data inputted to the data input box together with the data identifying information;
searching for the data corresponding to the data identifying information from the storage unit when transmitting to the terminal the definition information of the screen containing the data input box for the data specified by the data identifying information; and
setting the searched data into the data input box.

37. A program causing a computer transmit, to a terminal on a network, definition information of a screen containing a data input box for data specified by data identifying information and receive the data inputted to the data input box from the terminal, comprising the steps of:
communicating with the terminal via the network;
storing the data inputted to the data input box together with the data identifying information;
searching for the data corresponding to the data identifying information from a storage unit when transmitting to the terminal the definition information of the screen containing the data input box for the data specified by the data identifying information; and
setting the searched data into the data input box.
